(19) United States
(12) Patent Application Publication
(10) Pub. No.: US 2006/0047599 A1
(43) Pub. Date: Mar. 2, 2006

(54) Incremental funding method

(75) Inventors: Mark J. Denne, San Francisco, CA (US); Jane Huang, Flossmoor, IL (US)

Correspondence Address: BARNES & THORNBURG, LLP, P.O. BOX 2786, CHICAGO, IL, 60690-2786, US

(73) Assignees: Mark J. Denne; Jane Huang

(21) Appl. No.: 10/930,592

(22) Filed: Aug. 31, 2004

(51) Int. Cl. G06Q 40/00

(52) U.S. Cl. 705/39

(57) ABSTRACT

Provided is a method for developing a software product. The method can be implemented by stakeholders or by a service. Further, software can implement the method to provide project metrics before and during the development of the software product. The method identifies elements of the software product for development that have associated economic values for multiple time periods. The multiple time periods indicate the time to develop and then implement the software product. The elements can have dependencies that require the development of the elements as strands. Consequently, the strands also have economic values that are adjusted to permit the identification of the elements of the software product to develop.

### BACKGROUND

1. Field of the Invention

The present invention relates to managing a software project and, more particularly, to developing a software product.

2. Description of the Related Art

During a typical software development process, stakeholders interested in developing a software product evaluate the cost of development and the expected revenue generated by the sale of the software product. Costs of developing the software product include determining how many people will be involved and the acquisition of the infrastructure required during development. Further, expected revenue can be determined by assigning a price per unit to a completed software product and estimating the number of potential customers willing to pay the price per unit. By factoring the costs and expected revenue to develop a budget to find a software project, stakeholders with enough capital can initiate the software development process.

Stakeholders decide which features of the software product to include in the software product during a design and analysis stage of the software development process. A factor stakeholders may consider when including a particular feature is whether the particular feature can generate interest among potential customers to buy the software product. Other factors can also affect the decision of whether to add features, such as whether the features are mutually exclusive features or if the amount of features exceeds the costs of development. Typically, not all features are included in the software product because the software project to develop the software product has a limited budget.

For example, the software product can be a word processing application. Stakeholders interested in developing the word processing application may include features such as cut and paste and photo editing. Other features, such as the capability to open all types of word processing documents and zoom in on a document 1000% may not be included in the word processing application. Assuming the stakeholders would like to include all the features but exclude certain features because the budget is finite, a stakeholder with more power within a group may have her features included while a stakeholder with little power within the group may have his features excluded. Such power struggles within groups may not be the most efficient way to select features of a software product for development. For example, the stakeholders may not be fully informed regarding the financial aspects of developing the software product

Thus, what is needed is a financially rigorous method for determining which features of a software product should be included in a software project.

### SUMMARY

Broadly speaking, embodiments of the present invention provide a method of providing quantitative metrics to financially inform stakeholders interested in developing a software product during a software development process. It should be appreciated that the present invention can be implemented in numerous ways, such as a process, an apparatus, a system, a device or a method on a computer readable medium. Several inventive embodiments of the present invention are described below.

An embodiment of a method for developing a software product includes identifying a plurality of elements of the software product, such that each element is defined as a minimum marketable feature or an architectural element of the software product Further, the method includes identifying dependencies of each of the plurality of elements, such that the dependencies between the plurality of elements and each element define strands. Each strand, defined as a sequence of dependent features, has an economic value. The method also includes adjusting the economic value of each strand for a plurality of time periods to produce a plurality of adjusted economic values. The plurality of adjusted economic values is referenced to identify a particular adjusted economic value for a time period of the plurality of time periods. The particular adjusted economic value is used to identify which of the plurality of elements are to be included in the software product.

In an embodiment of a computer program embodied on a computer readable medium for developing a software product, the computer program includes instructions for identifying a plurality of elements of the software product. Each element is defined as a minimum marketable feature or an architectural element of the software product. Further, instructions identify constraints among each of the plurality of elements, such that the dependencies between the plurality of elements and each element define the strands. Each strand has an economic value. The computer program also includes instructions for adjusting the economic value of each strand for a plurality of time periods to produce a plurality of adjusted economic values. The plurality of adjusted economic values is referenced to identify a particular adjusted economic value for a time period of the plurality of time periods. The particular adjusted economic value is used to identify which of the plurality of elements are to be included in the software product.

In an embodiment of a method of developing a software product using a project management service, the method includes identifying a minimum marketable feature or an architectural element of the software product and identifying dependencies of the minimum marketable feature and the architectural element. The dependencies define strands, such that each strand has an economic value. The method also includes adjusting the economic value of each strand for a plurality of time periods to produce a plurality of adjusted economic values that are referenced to identify a particular adjusted economic value for a time period of the plurality of time periods. The particular adjusted economic value is used to identify which of the plurality of elements are to be included in the software product.

In an embodiment of an apparatus for developing a software product, the apparatus includes means for identifying a plurality of elements of the software product, such that each element is defined as a minimum marketable feature or an architectural element of the software product. The apparatus also includes means for identifying dependencies or precursors or precedence data of each of the plurality of elements, such that the dependencies between the plurality of elements and each element define strands. Each strand has an economic value. Further, the apparatus includes means for adjusting the economic value of each strand for a plurality of time periods to produce a plurality of adjusted economic values that are referenced to identify a particular adjusted economic value for a time period of the plurality of time periods. The particular adjusted economic value is used to identify which of the plurality of elements are to be included in the software product.

Other aspects of the invention will become apparent from the following detailed description, taken in conjunction with the accompanying drawings, illustrating by way of example the principles of the invention.

### BRIEF DESCRIPTION OF THE DRAWINGS

FIG. 1A is a diagram illustrating Incremental Funding Method (IFM) elements, in accordance with an embodiment of the invention;

FIG. 1B is a diagram illustrating a Minimum Marketable Feature (MMF), in accordance with an embodiment of the invention;

FIG. 2A is a diagram illustrating exemplary_feature descriptors, in accordance with an embodiment of the invention;

FIG. 2B is a diagram illustrating exemplary_MMF strands with dependencies, in accordance with an embodiment of the invention;

FIG. 3A is a diagram illustrating exemplary_Architectural Elements (AE), in accordance with an embodiment of the invention;

FIG. 3B is a diagram illustrating exemplary_AE descriptions, in accordance with an embodiment of the invention;

FIG. 4A is a diagram illustrating dependencies between MMFs and AEs, in accordance with an embodiment of the invention;

FIG. 4B is a diagram illustrating precedence data as strands, in accordance with an embodiment of the invention;

FIG. 4C is a diagram illustrating precursors of an IFM element, in accordance with an embodiment of the invention;

FIG. 4D is a diagram illustrating multiple children precedence data as strands, in accordance with an embodiment of the invention;

FIG. 5 is a diagram illustrating costs and returns of the IFM elements, in accordance with an embodiment of the invention;

FIG. 6 is a diagram illustrating sequence adjusted economic values, in accordance with an embodiment of the invention;

FIG. 7 is a diagram illustrating weighted sequence adjusted economic values, in accordance with an embodiment of the invention;

FIG. 8 is a diagram illustrating strands ordered by decreasing weighted sequence adjusted economic values for each time period, in accordance with an embodiment of the invention;

FIG. 9A is a diagram illustrating weighted sequence adjusted economic values for strands available during a first time period, in accordance with an embodiment of the invention;

FIG. 9B is a diagram illustrating weighted sequence adjusted economic values for strands available during a second time period following the selection of strand “1AB.,”, in accordance with an embodiment of the invention;

FIG. 9C is a diagram illustrating weighted sequence adjusted economic values for strands available during a third time period following the selection of strand “AB.C.,”, in accordance with an embodiment of the invention;

FIG. 9D is a diagram illustrating weighted sequence adjusted economic values for strands available during a fifth time period following the selection of strand “B.C.,” in accordance with an embodiment of the invention;

FIG. 9E is a diagram illustrating weighted sequence adjusted economic values for strands available during a seventh time period following the selection of strand “C.,” in accordance with an embodiment of the invention;

FIG. 10 is a diagram illustrating sequences having the highest economic values, in accordance with an embodiment of the invention;

FIG. 11A is a diagram illustrating a return on investment analysis of a sequence, in accordance with an embodiment of the invention;

FIG. 11B is a diagram illustrating a discounted cash flow analysis of a sequence, in accordance with an embodiment of the invention;

FIG. 11C is a diagram illustrating sequences ordered by breakeven time, in accordance with an embodiment of the invention;

FIG. 12A is a diagram illustrating concurrent development with weighted sequence adjusted economic values for strands available during a first time period, in accordance with an embodiment of the invention;

FIG. 12B is a diagram illustrating concurrent development with weighted sequence adjusted economic values for strands available during a second time period following the selection of strands “1AB.” and “2D.E.,” in accordance with an embodiment of the invention;

FIG. 12C is a diagram illustrating concurrent development with weighted sequence adjusted economic values for strands available during a third time period following the selection of strands “AB.C.” and “D.E.,” in accordance with an embodiment of the invention;

FIG. 12D is a diagram illustrating concurrent development with weighted sequence adjusted economic values for strands available during a fourth time period following the selection of strand “B.C.,” in accordance with an embodiment of the invention;

FIG. 12E is a diagram illustrating concurrent development with weighted sequence adjusted economic values for strands available during a fifth time period following the selection of strand “E.,” in accordance with an embodiment of the invention;

FIG. 12F is a diagram illustrating concurrent development with weighted sequence adjusted economic values for strands available during a sixth time period following the selection of strand “C.,” in accordance with an embodiment of the invention;

FIG. 12G is a diagram illustrating concurrent development with weighted sequence adjusted economic values for a strand available during a seventh time period following the selection of strand “3F.,” in accordance with an embodiment of the invention;

FIG. 13A is a diagram illustrating concurrent development of two strands over multiple time periods, in accordance with an embodiment of the invention;

FIG. 13B is a diagram illustrating a financial analysis of the concurrent development and delivery of two strands, in accordance with an embodiment of the invention;

FIG. 14 is a flowchart diagram illustrating the Incremental Funding Method (IFM), in accordance with an embodiment of the invention; and

FIG. 15 is a diagram illustrating project metrics of IFM, in accordance with an embodiment of the invention.

### DETAILED DESCRIPTION

Various embodiments for developing a software product are disclosed. The embodiments described herein provide quantitative metrics to financially inform stakeholders interested in developing the software product during an entire software development process. Specifically, Minimum Marketable Features (MMFs) and Architectural Elements (AEs) of a software product are defined, such that each minimum marketable feature and architectural element has a financial value. Subsequently, the MMFs and AEs are sequenced using a heuristic or algorithm with the objective of maximizing one or more economic values over multiple time periods and/or providing financial information to stakeholders during the entire software development process. One such heuristic or algorithm is the “IFM heuristic”. This document assumes the use of the IFM heuristic for the purposes of explanation and example, but the available heuristics or algorithms are not limited to the IFM heuristic.

In one embodiment, a computer system (not shown) includes components in an exemplary hardware configuration for executing the IFM heuristic. For example, the exemplary hardware configuration includes a processor, memory, and devices that are connected together by a system bus. The processor can include multiple execution units and caches organized in a core. Further, processors having multiple cores can be called “multi-core” processors. To one of ordinary skill in the art, the computer system can also include multiple processors. Thus, any amount and type of processors are possible, as long as the processors are capable of executing the IFM heuristic.

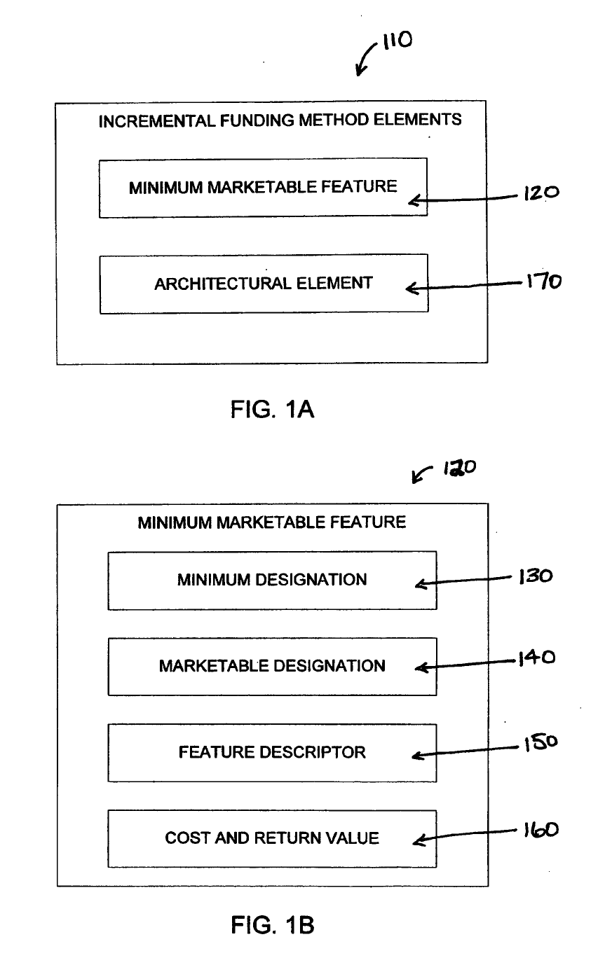

In other embodiments, a network of computer systems, whether wireless or wire-based, execute the IFM heuristic. Further, other exemplary embodiments incorporating the IFM heuristic also include services and products that manage the software development process. For example, a software service can incorporate the IFM heuristic to provide stakeholders the financial information needed to determine which features, or elements, are to be included in the software product Specifically, FIG. 1A is a diagram illustrating Incremental Funding Method (IFM) elements, in accordance with an embodiment of the invention. An IFM element 110 includes either a Minimum Marketable Feature (MMF) 120 or an Architectural Element (AE) 170. The MMF 120 represents a component having an intrinsic marketable value.

For example, a banking application that enables customers to check an account balance, although the banking application does not yet include the ability to withdraw or deposit funds, is an example of a software product with three exemplary_MMFs 120. Each MMF 120 has an intrinsic marketable value. One MMF 120 provides customers the ability to check account balances. Two other MMFs 120 provide the ability to withdraw funds and deposit funds. Thus, in this example, although the banking application with all three MMFs 120 is not complete, providing access to the banking application to check balances creates market value. If stakeholders invest funds to develop the check balances MMF 120, then there is a return on the investment even before the completion of the full-featured banking application. Thus, by decomposing the banking application into multiple MMFs 120 with intrinsic marketable values, the software product can be decomposed into separate components that can have immediate returns on investment.

The AEs 170 are processes or pieces of architecture, such as computers, networking infrastructure, or other tools, that an MMF 120 may depend on in order for the MMF 120 to function. AEs 170 are sequenced along with MMFs 120. However, in contrast to the MMF 120, which has an intrinsic marketable value and provides a return value, the AE 170 does not provide a return value. Initial investments for AEs 170 are costs that are factored into the economic analysis in order to obtain a functioning MMF 120.

FIG. 1B is a diagram illustrating a Minimum Marketable Feature (MMF) 120, in accordance with an embodiment of the invention. The MMF 120 includes a minimum designation 130, a marketable designation 140, a feature descriptor 150, and a cost and return value 160. The minimum designation 130 identifies that the MMF 120 is the minimum feature of a software product that has intrinsic marketable value. The marketable designation 140 identifies a marketable value of the MMF 120 to the customer. For example, MMFs 120 create marketable value by fostering competitive differentiation, revenue generation, cost saving, brand projection, enhanced loyalty, or other perceived value. The feature descriptor 150 identifies a name of the MMF 120, such as “check account balances” of the banking application. The cost and return value 160 are values of “check account balances” represented as cash flow over a specified time period.

For example, the MMF 120 of “check account balances” can require an investment of $250,000 U.S. Dollars ($250K USD) from the stakeholders in a first time period to develop the MMF 120. In a second time period, the MMF 120 is available to customers and the MMF 120 returns $50K (USD) to the stakeholders. During a third time period, the MMF 120 returns another $50K to the stakeholders and in a fourth time period, the MMF 120 returns $80K to the stakeholders. Thus, the cost and return values 160 of “check account balances” has an initial cost of $250K in the first time period and increasing returns in subsequent time periods. Time periods are well known to those of ordinary skill in the art. For example, time periods can include days, months, years, or any unit of time, as long as the time periods permit the identification of cost and return values 160 over the time periods.

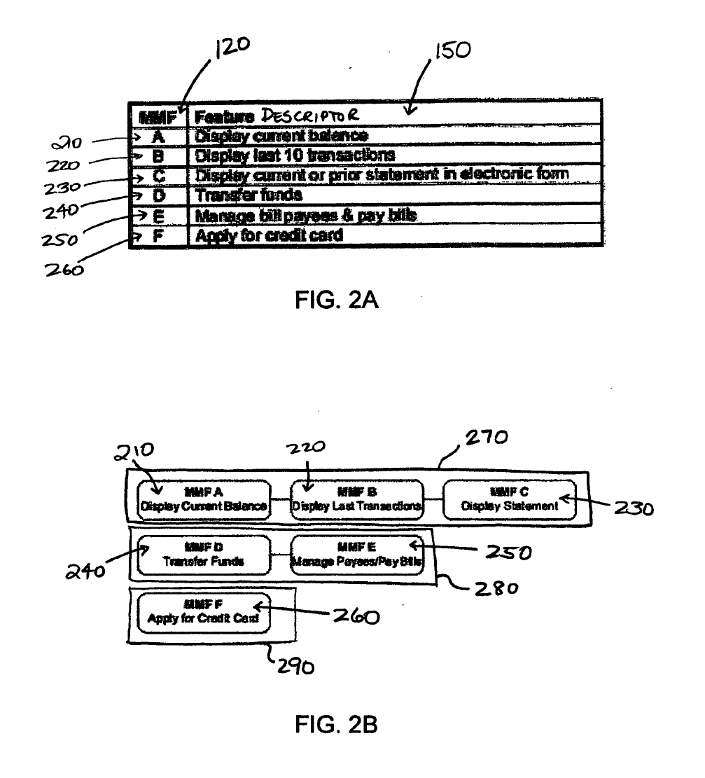

FIG. 2A is a diagram illustrating exemplary_feature descriptors 150, in accordance with an embodiment of the invention. Multiple MMFs 120 such as an MMF-A 210, an MF-B 220, an MMF-C 230, an MMF-D 240, an MMF-E 250, and an MMF-F 260, each have feature descriptors 150. For example, if the software product is a banking application, then the MMF-A 210 displays a current balance. The MMF-B 220 displays the last 10 transactions. The MMF-C 230 displays the current or prior bank statement in electronic form and the MMF-D 240 transfers funds. The MMF-E 250 manages bill payees and pays bills and the MMF-F 260 permits applications for a credit card.

Individually, each MMF 120 has a cost and return value 160. However, if stakeholders wish to implement the MMF-B 220, then the stakeholders have to account for dependencies between the MMFs 120. For example, FIG. 2B is a diagram illustrating exemplary MMF strands with dependencies, in accordance with an embodiment of the invention. The MMF-A 210, MMF-B 220, and MMF-C 230 define a first-strand 230. The first-strand 230 illustrates that the MMF-C 230 cannot be completed without first completing the development of the MMF-B 220. In turn, the MMF-B 220 cannot be completed without first completing the development of the MMF-A 210. Correspondingly, the MMF-D 240 and the MMF-E 250 define a second-strand 280. The second-strand 280 illustrates that the MMF-E 250 is dependent on the completed development of the MMF-D 240. A third-strand 290 illustrates that the MMF-F 260 has no dependencies and can be developed independently of any other MMF or strand.

The strands also have sub-strands. For example, the sub-strands of the second-strand 280 include a sub-strand MMF-D and a sub-strand MMF-E. For simplicity, all sub-strands are called strands. Accordingly, all strands are composed of individual IFM elements 110 or combinations of IFM elements 110.

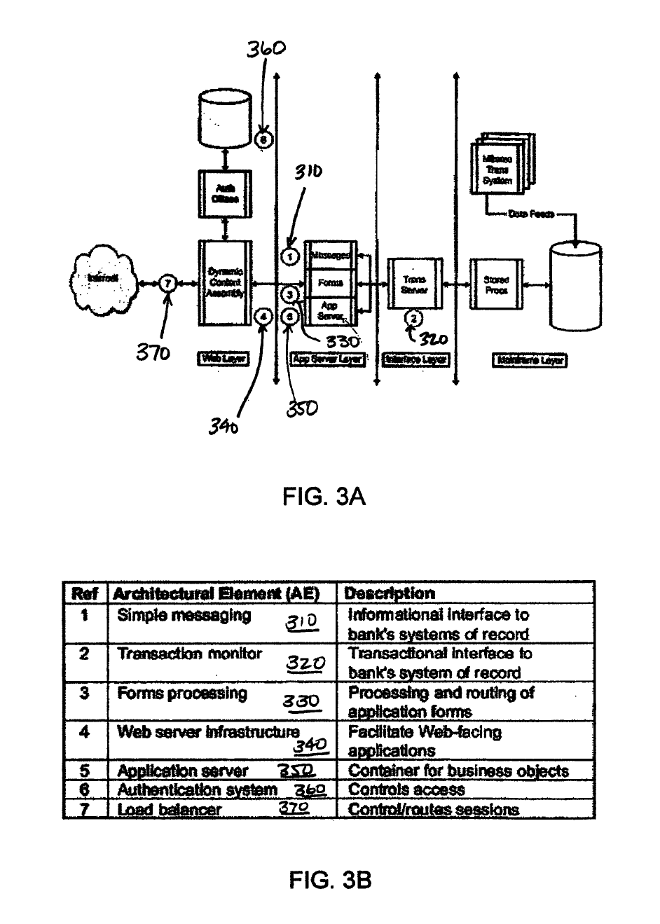

FIG. 3A is a diagram illustrating exemplary Architectural Elements (AEs), in accordance with an embodiment of the invention. The banking application previously described can be supported by an architectural system including multiple AEs 170. The exemplary architectural system of FIG. 3A includes a simple messaging system 310, a transaction monitor 320, forms processing 330, a web server infrastructure 340, an application server 350, an authentication system 360, and a load balancer 370. One of ordinary skill in the art will recognize that the AEs 170 include database management systems, networking infrastructure, operating systems, middleware and other software. However, the AEs 170 are not MMFs 120 of the banking application because the AEs have cost values, but no return values. FIG. 3B is a diagram illustrating exemplary AE descriptions, in accordance with an embodiment of the invention. For example, the simple messaging system 310 is the informational interface to the bank's systems of record. Forms processing 330 provides the capability to process and route application forms. Similarly, the other AEs 170 of FIG. 3A have corresponding descriptions in FIG. 3B.

Stakeholders interested in developing the banking application must acquire the AEs 170 at a cost. For example, acquiring the simple messaging system 310 may cost the stakeholders $20K (USD). Instead of developing the AEs 170 themselves, stakeholders may decide to hire a third party to develop and construct some or all of the AEs 170. Specifically, hiring the third party may allow stakeholders to focus energies and personnel on developing MMFs 120, instead of AEs 170, which only have cost values.

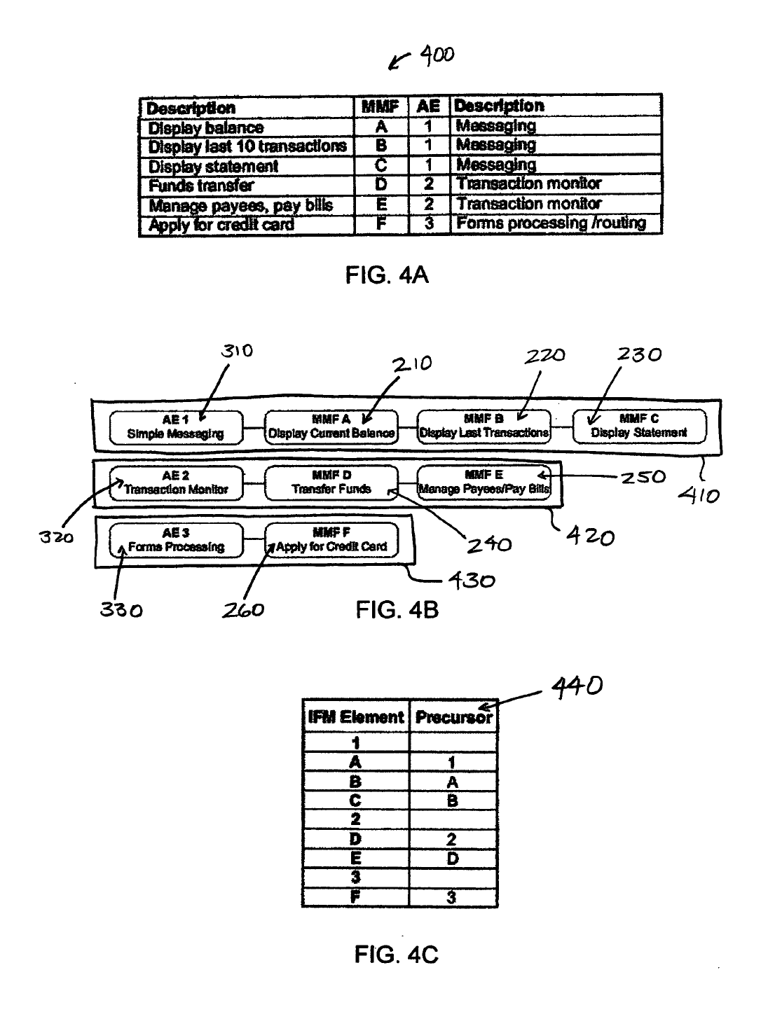

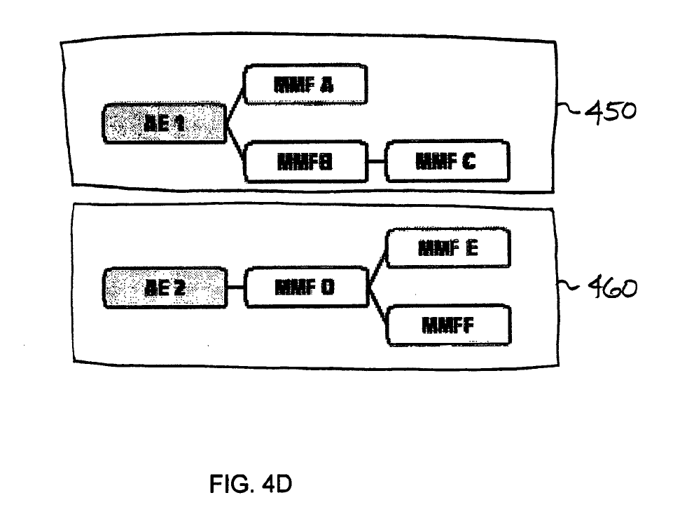

FIG. 4A is a diagram illustrating dependencies between MMFs and AEs, in accordance with an embodiment of the invention. Specifically, architectural dependencies 400 exist between the MMFs 120 and the AEs 170. To develop MMF-A 210, which displays the current balance, the simple messaging system 310 must first be developed and constructed. Similarly, MMF-B 220, which displays the last 10 transactions, and MMF-C 230, which displays the current or prior statement in electronic form, also requires the development of the simple messaging system 310. Thus, as further illustrated in FIG. 4A, MMF-D 230 and MMF-E 250 are dependent on the development of the transaction monitor 320 and MMF-F 260 is dependent on the development of forms processing 310.

The dependencies of MMF-A through MMF-F can be illustrated as precedence data. Specifically, FIG. 4B is a diagram illustrating precedence data, in accordance with an embodiment of the invention. For example, a strand-1 410 illustrates that MMF-A 210, MMF-B 220 and MMF-C 230 are dependent on the simple messaging system 310. Further, a strand-2 420 illustrates that MMF-D 240 and F-E 250 are dependent on the transaction monitor 320. Finally, MMF-F 260 is dependent on forms processing 330. The strand-1 410, strand-2 420 and strand-3 430 are independent of one another. Thus, for example, there are no dependencies between the MMF-F 260 and the transaction monitor 320.

The strands of FIG. 4B further illustrate the dependencies as precursors. Specifically, a precursor can be a development precursor, which means that the IFM elements 110 are developed sequentially. Alternatively, the precursor can be a delivery precursor, which means that the IFM elements 110 are not developmentally dependent on one another and can be developed in parallel, but have to be delivered sequentially. FIG. 4C is diagram illustrating precursors 440 of an IFM element, in accordance with an embodiment of the invention. Specifically, assuming that the IFM elements 110 of the strands of FIG. 4B are development precursors, developing MMF-A 210 requires the precursor 440 of the simple messaging system 310. Developing MMF-B 220 requires the precursor 440 of MMF-A 210. Similarly, developing MMF-C 230 requires the precursor 440 of MMF-B 220. Thus, the strand-1 410 requires sequential development of the IFM elements 110.

In another embodiment, the strands of FIG. 4B can have IFM elements 110 that are delivery precursors. These precursors will be described in relation to concurrent development of strands. Further, other embodiments of strands can include AEs 170 that are not the first IFM elements 110 of the strands. Specifically, AEs 170 can be developed after developing MMFs 120. Further, IFM elements 110 can have multiple dependencies. For example, FIG. 4D is a diagram illustrating multiple children precedence data as strands, in accordance with an embodiment of the invention. A strand-4 450 illustrates that an AE-1 is a precursor 440 of MMF-A and MMF-B. Similarly, a strand-5 460 illustrates that an MMF-D is a precursor 440 of MMF-E and MMF-F. Thus, any suitable precedence data of strands is possible, as long as the precedence data define the relationships between IFM elements 110.

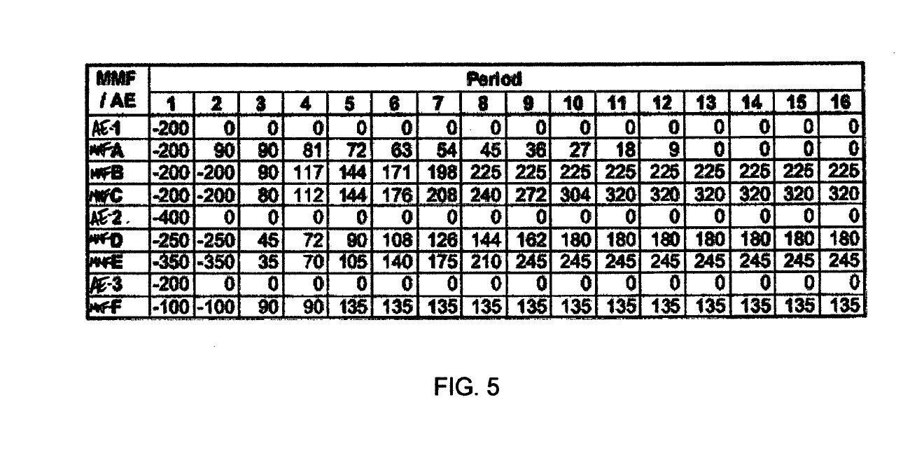

FIG. 5 is a diagram illustrating costs and returns of the IFM elements 110, in accordance with an embodiment of the invention. During sixteen time periods, the IFM elements 110 of MMF-A through MMF-F and AE-1 through AE-3 have corresponding cost and return values. Specifically, while the MMFs 120 have both cost and return values, the AEs 170 only have costs. For example, AE-1 and AE-3 each have costs of $200K in the first time period. AE-2 has a cost of $400K in the first time period. In subsequent time periods, AE-1, AE-2, and AE-3 have no other cost values. Alternatively, MMF-A has a cost of $200K in the first time period, but from the second to twelfth time periods, MMF-A has return values. For example, MMF-A generates a return of $90K for each of the second and third time periods During the thirteenth to the sixteenth time period, MMF-A ceases to have return values. In contrast, MMF-F has costs of $100K for the first two time periods, but has return values of $90K for the third and fourth time periods. Subsequently, MMF-F has return values of $135K for the remaining time periods.

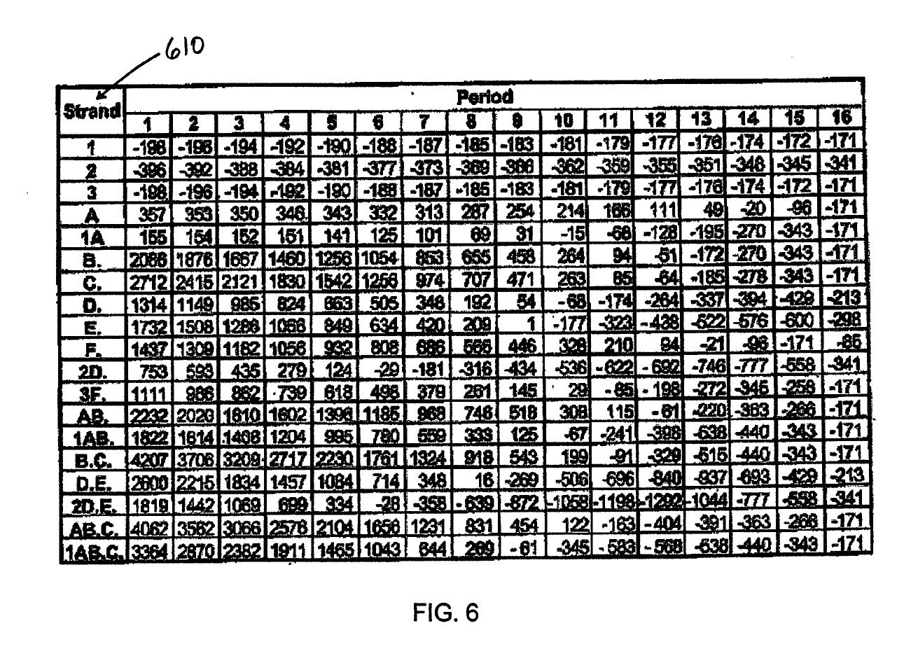

By identifying dependencies of the IFM elements 110 such that the IFM elements 110 define strands, each strand can have an economic value. Further, the economic value of each strand for multiple time periods can be adjusted to produce multiple adjusted economic values. An example of strands with economic values that are adjusted for multiple time periods is illustrated in FIG. 6. Specifically, FIG. 6 is a diagram illustrating sequence adjusted economic values, in accordance with an embodiment of the invention. Strands 610 include individual IFM elements 110 such as AE-1, AE-2, AE-3, and MMF-A. For simplicity, individual AEs 170 are represented numerically and MMFs 120 are represented alphabetically. Thus, for a strand 610 such as the strand-1 410 (FIG. 4B), the corresponding strand 610 is represented as 1ABC. However, the strands 610 of FIG. 6 include a notation to represent the amount of time periods required to develop an IFM element 110. For example, “B.” indicates that two time periods are required to develop MMF-B. If MMF-B requires the first three time periods for development, then the representation of the strand 610 is “B.”

Further, the notation indicates a particular sequencing of time periods. For example, “1AB.C.” as illustrated in FIG. 6, indicates that the strand 1ABC is developed during the following time periods. Architectural element “1” is developed during the first time period. Then, minimum marketable feature “A” is developed in the second time period. Subsequently, “B.” requires the third and fourth time periods for development and “C.” requires the fifth and sixth time periods for development Thus, six time periods are required to develop the strand 610 “1AB.C.”

In one exemplary embodiment, the economic values are Net Present Values (NPV). However, any suitable economic value is possible, as long as the economic value permit adjustments to produce adjusted economic values. It is illustrative to describe the development of NPV in terms of money. Money, represented by costs and returns of the IFM elements 110 of FIG. 5, has a time value. For example, a banking application that delivers $1 million (USD) in savings to stakeholders in one year is more valuable than a banking application that delivers $1 million (USD) in 20 years. The value of the $1 million (USD) over time can be quantified by discounting the $1 million (USD) against a selected interest rate. This calculation determines the Present Value (PV) of the future cash. For example,
PV=$x/(1+i/100)ⁿ
is the present value (PV) of $x in n year's time at i%. Thus, if the interest rate is 5% a year, receiving $1 million in 20 years is equivalent to gaining approximately $377,000 (USD) now (i.e. $377K=$1 million divided by (1+0.05)²⁰). Alternatively, receiving $1 million in one year is equivalent to gaining approximately $952K (USD) now (i.e. $952K=$1 million divided by (1+0.05)¹). Thus, the cash flows, or cost and return values of FIG. 5 can be adjusted with PV to generate the Discounted Cash Flow (DCF). Consequently, the sum of the DCFs over the multiple time periods produces Net Present Values (NPV), which are economic values of an embodiment of the present invention. The calculations starting from cost and return values to NPV can be further referenced in “Software By Numbers Low-Risk, High Return Development,” authored by Mark J. Denne and Jane Cleland-Huang, hereinafter incorporated by reference in its entirety.

Returning to the illustration of FIG. 6, the NPVs of each strand 610 are determined for each time period. FIG. 6 illustrates sequence adjusted net present values (SANPV) for each strand. Applying a 1% discount rate per time period generates these particular SANPVs. Examining the SANPVs results in some observations. First, the architectural elements, “1,” “2,” and “3” have negative SANPVs for all time periods because the AEs have no return values. Second, the minimum marketable feature “A” has positive SANPVs for periods 1 through 13, indicating that it would be profitable to develop “A” during the first thirteen periods. However, because “A” has a development precursor of “1,” as illustrated in FIG. 4C, “A” can only be sequenced as part of the strand or substrand “1A.” The strand “1A.” has positive SANPVs for periods 1 through nine, indicating that it would be profitable to develop “1A.” during the first nine periods.

A third observation is that a longer strand 610, such as “1AB.C.” has positive SANPVs for the first eight time periods. Thus, when compared to the strand “1A.”, the strand “1AB.C.” is profitable for only eight periods instead of nine periods. In addition, the longer strand “1AB.C.” takes a longer time to develop than “1A.”

Although the observations of SANPVs aid in the selection of strands 610 to develop, a heuristic or algorithm is required to permit the selection of the optimal, or near optimal, development sequence. One might imagine that the optimal, or near optimal, development sequence can be chosen by selecting those strands that have the most attractive economic value at each time period in the plurality of time periods. This approach, referred to as the “greedy approach” is described below.

Returning to FIG. 6, strand “1A” has a value of $155K if development is started in period 1. Strand “2D.” has a value of $753K if development is started in period 1. Further, “3F.” has a value of $1,111K if development is started in period 1. Thus, the greedy approach would choose to start development with strand “3F.”. The strand “3F.” takes 3 periods to develop. Thus, in the fourth period, the available strands to develop are “1A” which has a value of $151K in development is started in the fourth period and strand “2D.,” which has a value of $279K if development is started in the fourth period. The greedy approach therefore selects strand “2D.” The strand “2D.” is developed during periods 4 through 6, so in period 7, the available strands are “1A” and “E.” in period 7, “1A” has a value of $101 K and “E.” has a value of $420K. Thus, the greedy approach will select to develop “E.” at period 7. In period 9 there are no strands remaining with positive values. Thus, the greedy approach selects the sequence “3F.2D.E.” for development and terminates development after eight time periods.

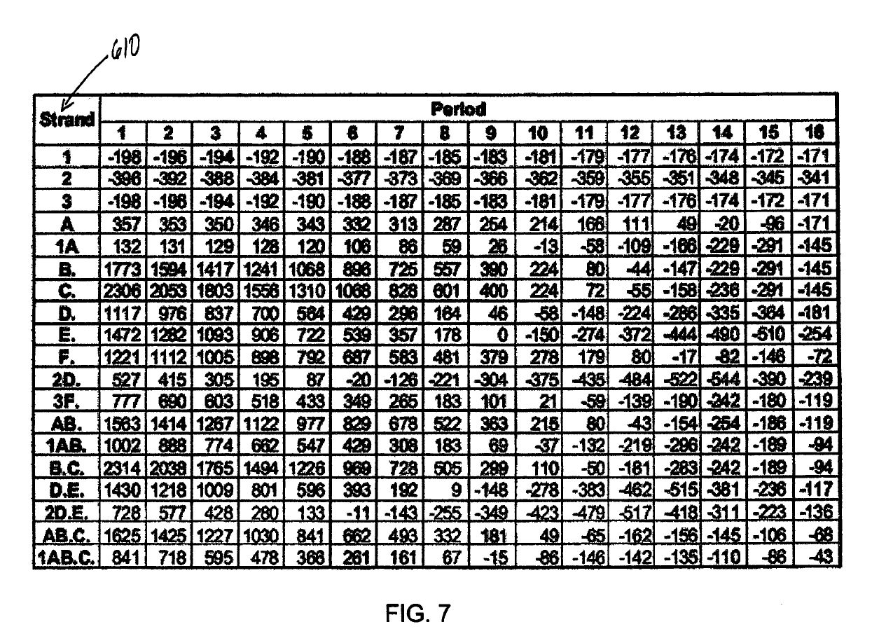

However, using the greedy approach may not determine an optimal strand for development For example, FIG. 7 is a diagram illustrating weighted sequence adjusted economic values, in accordance with an embodiment of the invention. By weighting the SANPVs for multiple time periods, and thus performing another adjustment, weighted sequence adjusted NPVs (WSANPVs) are determined. For example, a formula
WSANPV=SANPV×(1−(weight factor×(p−1)))
determines WSANPV by using a weighting factor of a number of periods “p” in the 5 currently evaluated strand. Selection of the weighting factor varies according to factors such as the number of available time periods, the number of MMFs in the selection pool and the average strand length. For example, using a weighting factor of 15% for the 16 time periods of FIG. 7, the WSANPV of strand “1A” at time period 1 is $155K×(1−(0.15×(2−1))), or approximately $132K. By determining the WSANPVs of each strand for all time periods, the EFM heuristic permits the application of IFM sequencing strategies for selecting strands 610 for development. Further, an objective of the IFM heuristic is to choose the best possible strand 610 with the highest economic value, while considering precursors. Thus, the IFM heuristic provides the capability to look ahead from earlier to later time periods, regardless of strand 610 length.

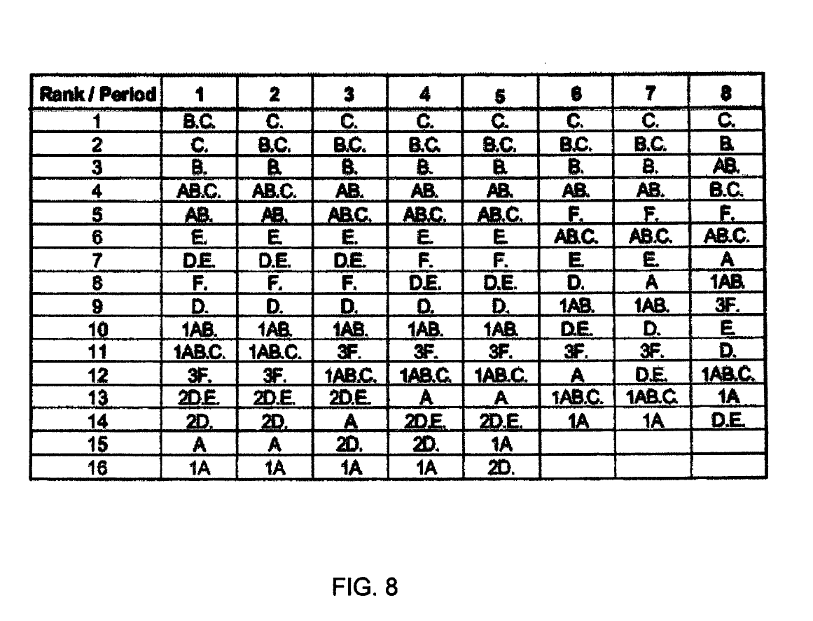

FIG. 8 is a diagram illustrating strands ordered by decreasing weighted sequence adjusted economic values for each time period, in accordance with an embodiment of the invention. By ordering the strands 610 of FIG. 7 by decreasing WSANPVs per time period, it is easier to identify which strands 610 are appropriate for development. Assuming that there are 8 time periods for development, the strands 610 are ordered as illustrated in FIG. 8. However, not all the strands 610 can be developed. Specifically, by filtering out strands 610 with unfulfilled precursors, such as “B.C.” and “A,” there are only nine strands 610 available for analysis.

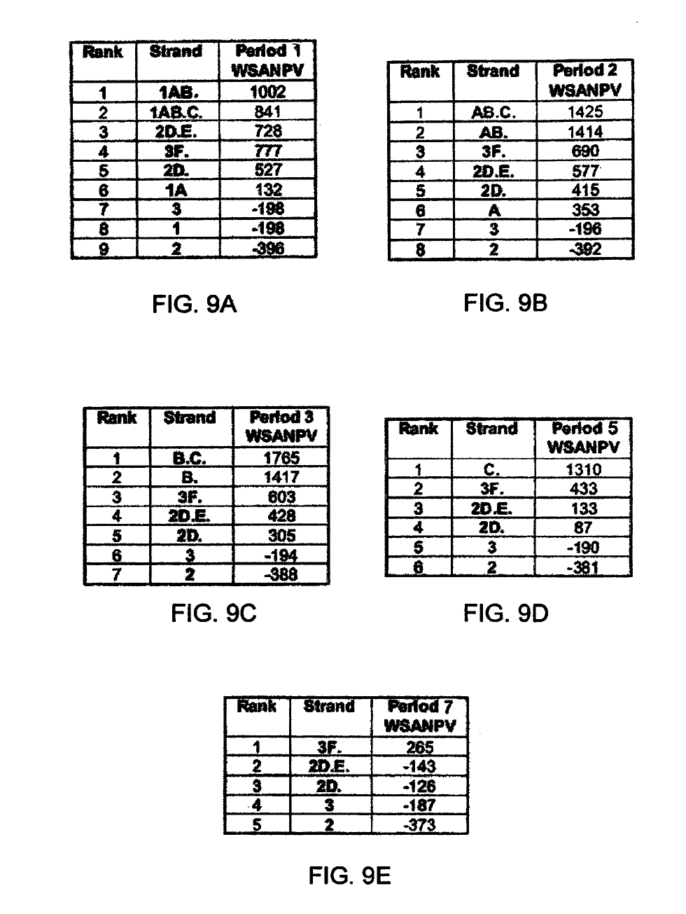

Specifically, FIG. 9A is a diagram illustrating weighted sequence adjusted economic values for strands available during a first time period, in accordance with an embodiment of the invention. The nine strands 610 are ranked from 1 to 9, with the strand “1AB.” having the rank of 1 and the strand “2” having the rank of 9. Each of the substrands “3”, “2”, and “1” are individual architectural elements 1-3. Further, the strands 610 are ordered by WSANPV. In one exemplary embodiment, stakeholders interested in developing the banking application previously described may limit the development period to eight time periods. For example, strand “1AB.” is selected and AE-1 is scheduled for development in period 1. Subsequently, FIG. 9B illustrates weighted sequence adjusted economic values for strands available during a second time period following the selection of strand “1AB.”, in accordance with an embodiment of the invention. During period 2, the strand “AB.C.” has the highest WSANPV. Thus, MMF-A is scheduled for development in period 2. Further, FIG. 9C is a diagram illustrating weighted sequence adjusted economic values for strands available during a third time period following the selection of strand “AB.C.,” in accordance with an embodiment of the invention. The highest valued strand 610 in period 3 is “B.C.” Thus, MMF-B is scheduled for development in periods 3 and 4.

Next, FIG. 9D is a diagram illustrating weighted sequence adjusted economic values for strands available during a fifth time period following the development of strand “B.C.,” in accordance with an embodiment of the invention. Strand MMF-C is scheduled for development in periods 5 and 6. Finally, FIG. 9E is a diagram illustrating weighted sequence adjusted economic values for strands available during a seventh time period following the selection of substrand “C.,” in accordance with an embodiment of the invention. Thus, with only 8 development periods available, the IFM heuristic identifies strand “1AB.C.” for development during those eight time periods. Although the remaining IFM elements 110 are not developed, the IFM heuristic provides a method of determining the best features to develop within a set time period to produce the highest return on investment.

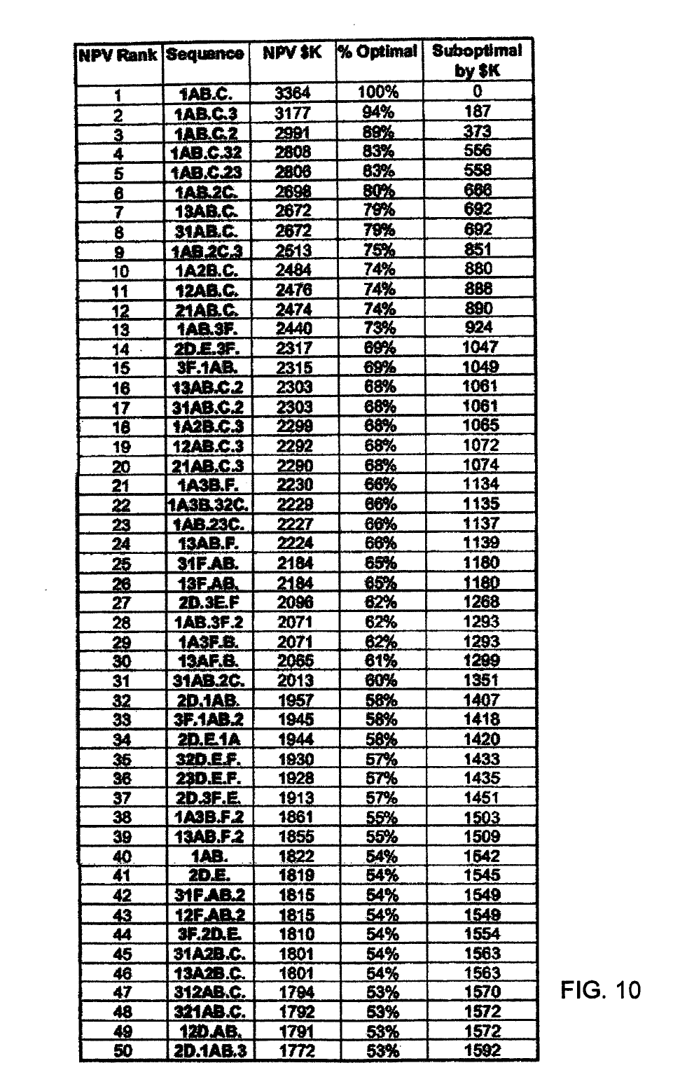

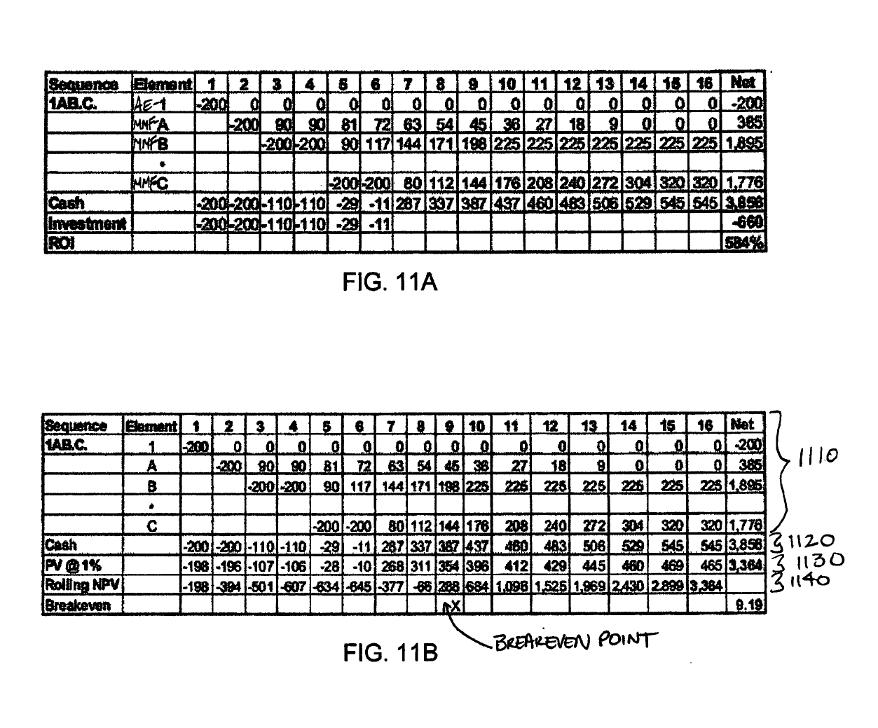

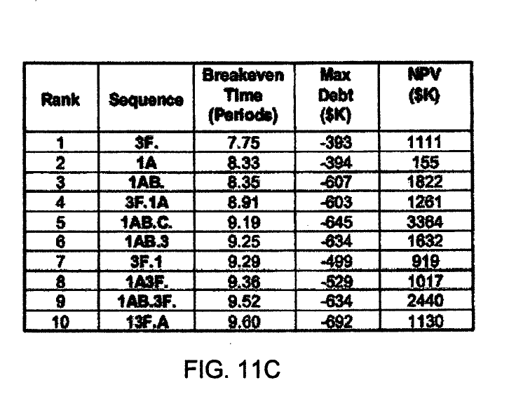

Specifically, FIG. 10 is a diagram illustrating some of the sequences with the highest economic values, defined in terms of NPV (Net Present Value) in accordance with an embodiment of 20 the invention. For example, the sequence “1AB.C.” has an NPV of $3,364K. In contrast, the sequence “3F.2D.E,” selected using the greedy approach has an NPV of $1,810K. Further, if the stakeholders chose to develop all the IFM elements 110 of the banking application using the sequence “321AB.C.”, then the NPV is $1,792K. It is illustrative to evaluate the return on investment of the development sequence “1AB.C.” during 8 time periods, as shown in FIG. 11A

FIG. 11A is a diagram illustrating a return on investment analysis of a sequence, in accordance with an embodiment of the invention. Referring the FIG. 5, AE-1 costs $200K in the first time period. Then, MMF-A costs $200K for the second time period and begins to return in the third period. MMF-B costs $200K for the third and fourth time periods and begins to return in the fifth time period. Finally, MMF-C costs $200K for the fifth and sixth time periods and begins to return in the seventh time period. Ultimately, with an investment of $660K for the first six time periods, the return is $3,856K, resulting in a return on investment of 584% over that time period.

Another financial analysis involves determining the breakeven point for developing a strand. FIG. 11B is a diagram illustrating a discounted cash flow analysis of a sequence, in accordance with an embodiment of the invention. For example, the sequence “1AB.C.” has cost and return values 1110, similar to FIG. 11A. However, FIG. 11B also shows cash positions 1120. Further, a present value (PV) 1130 is calculated from the cash positions 1120 using 1% per time period. Consequently, a rolling net present value (NPV) 1140 shows the sum of the PVs 1130 of earlier time periods. For example, at time period 9, “288” indicates the sum of “354” and “−66.” Consequently, time period 9 is the breakeven point.

FIG. 11C is a diagram illustrating sequences ordered by breakeven time, in accordance with an embodiment of the invention. In contrast to the ranking of FIG. 10, the strands 610 are ordered by breakeven time. Specifically, while the sequence “1AB.C.” has an NPV of $3,364K, the fastest breakeven time is achieved with the sequence “3F.”. In particular, strand “3F.” breaks even at time period 7, while strand “1AB.C.” breaks even at time period 9.

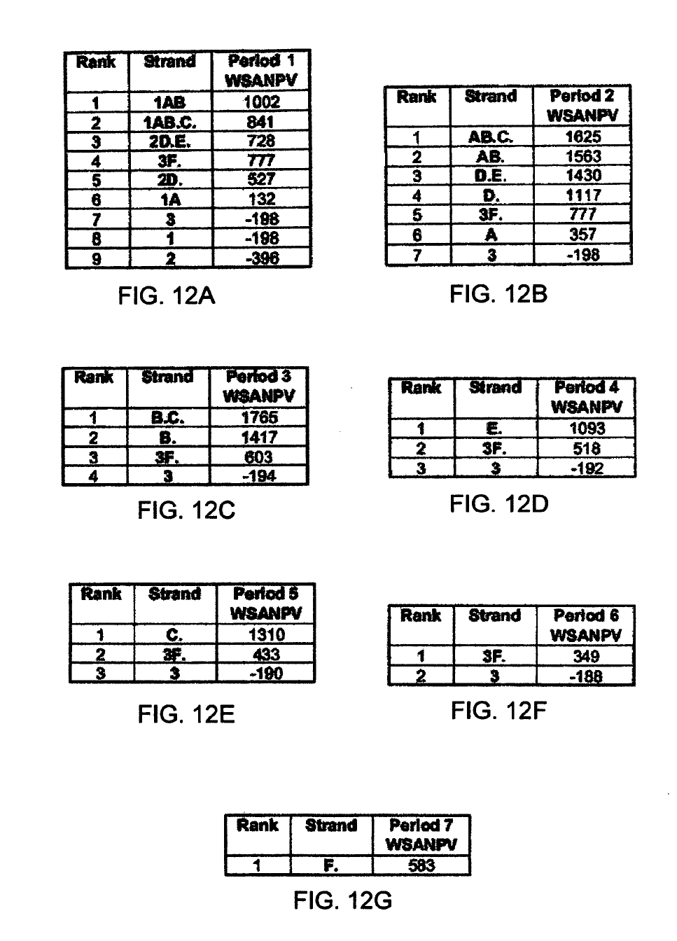

FIG. 12A is a diagram illustrating concurrent development with weighted sequence adjusted economic values for strands available during a first time period, in accordance with an embodiment of the invention. Specifically, instead or developing sequence “1AB.C.” serially during eight time periods, the IFM heuristic can evaluate multiple strands to develop concurrently during eight time periods. For example, in time period 1, the strands “1AB.” and “2D.E.” are selected. In this example, the MMws 120 within a strand require sequential development. Thus, the MMF-B of “AB” cannot be developed until MMF-A is completed and accordingly AE-1 and AE-2 are scheduled for development during time period 1.

Then, FIG. 12B illustrates concurrent development with weighted sequence adjusted economic values for strands available during a second time period following the selection of strands “1AB.” and “2D.E.,” in accordance with an embodiment of the invention. Strand “AB.C.” is selected along with strand “D.E.” Thus, MMF-A and MMF-D are scheduled for development during time period 2. Next, FIG. 12C is a diagram illustrating concurrent development with weighted sequence adjusted economic values for strands available during a third time period_following the selection of strands “AB.C.” and “D.E.,” in accordance with an embodiment of the invention. MMF-D requires two time periods for development. So during the third time period, MMF-B of the strand “B.C.” is scheduled for development. Subsequently, FIG. 12D is a diagram illustrating concurrent development with weighted sequence adjusted economic values for strands available during a fourth time period following the selection of strand “B.C.,” in accordance with an embodiment of the invention. MMF-B requires two time periods for development, so after MMF-D is complete, strand “E.” is scheduled for development.

FIG. 12E is a diagram illustrating concurrent development with weighted sequence adjusted economic values for strands available during a fifth time period following the selection of strand “E.,” in accordance with an embodiment of the invention. While MMF-E is under development, the strand “C.” is scheduled for development MMF-C also requires two time periods for development. FIG. 12F is a diagram illustrating concurrent development with weighted sequence adjusted economic values for stands available during a sixth time period following the selection of strand “C.,”, in accordance with an embodiment of the invention. The strand “3F.” is selected and AE-3 is scheduled for development in time period 6. Finally, FIG. 12G is a diagram illustrating concurrent development with weighted sequence adjusted economic values for a strand available during a seventh time period following the selection of strand “3F.,”, in accordance with an embodiment of the invention. The remaining strand “F.” is then scheduled for development during periods 7 and 8.

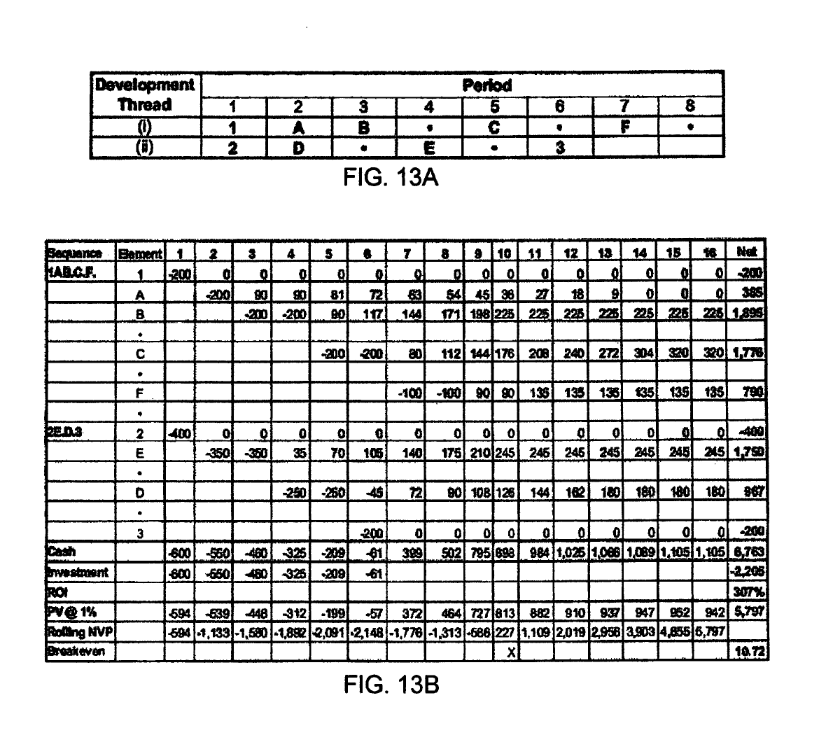

FIG. 13A is a diagram illustrating concurrent development of two strands over multiple time periods, in accordance with an embodiment of the invention. Specifically, the banking application can be fully developed within eight time periods by the concurrent development of strands “2D.E.3” and “1AB.C.F.” FIG. 13B is a diagram illustrating a financial analysis of the parallel delivery of two strands, in accordance with an embodiment of the invention. The IFM analysis provides quantitative metrics during multiple time periods. Thus, FIG. 13B illustrates that for 16 time periods, the aforementioned banking application has a net return of $6,763K for a total investment of $2,205K. This results in an overall return on investment of 307% for the parallel delivery of strands of “1AB.C.F.” and “2E.D.3,” which is less than the return on investment of 584% for the delivery of one strand “1AB.C.,” as illustrated in FIG. 11A. Further, while only $660K of investment is required to develop strand “1AB.C.,” $2,205K is required to develop the parallel strands. However, increasing the investment permits the development of all the features of the banking application within eight time periods.

Another difference between single strand delivery and parallel delivery of two strands in this example is that the breakeven point is increased to period 10 in the parallel delivery option. The added time period to break even may be cost prohibitive because the stakeholders may not be able to wait the additional time period. Whether the stakeholders decide on single delivery of some of the features of the banking application instead of all the featues is a business decision. However, by using the IFM principles the stakeholders can make an informed business decision.

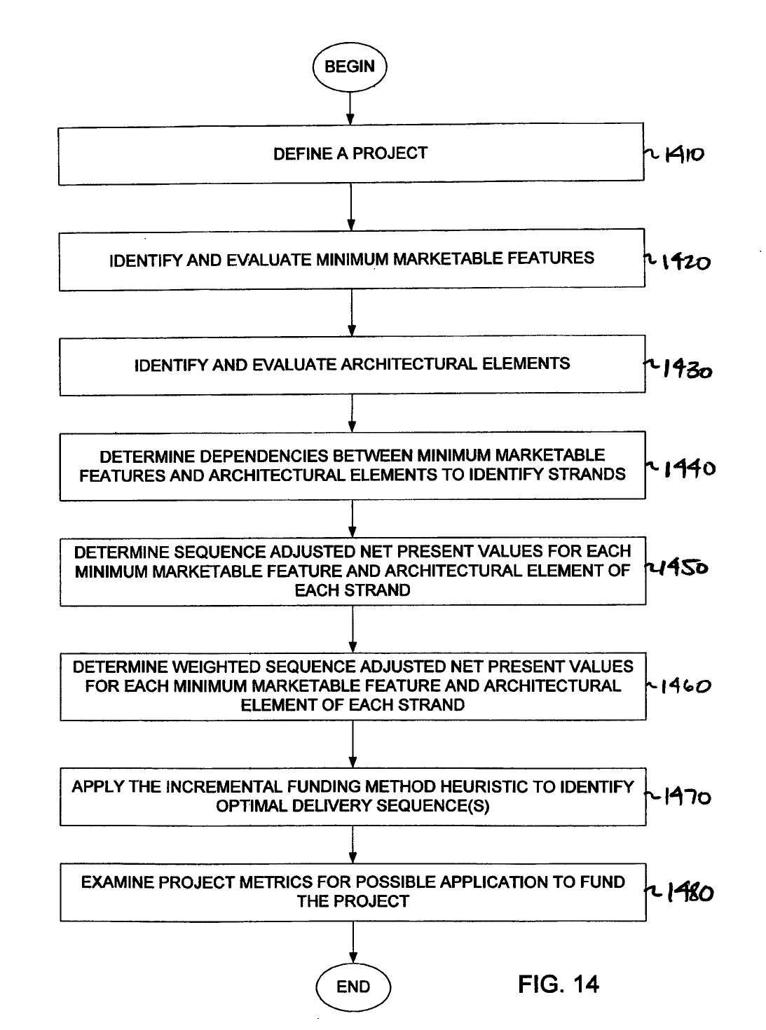

FIG. 14 is a flowchart diagram illustrating the Incremental Funding Method (IFM), in accordance with an embodiment of the invention. The flowchart includes operations illustrating a sequence. However, other embodiments of the invention are not limited by the sequence. For example, the operations may be performed in parallel by a computing system having a pipelined architecture.

Thus, in operation 1410, stakeholders can define a project. Specifically, the stakeholders can develop a software product during the project. It should be appreciated that stakeholders need not be individuals, but can be organizations or systems having input as to the required features of the software product. Thus, a stakeholder is any entity that has a position with respect to the outcome of the development of a software product

In operation 1420, the stakeholders can identity and evaluate minimum marketable features of the software product. The minimum marketable features each have economic values that can be represented as cost and return values. The cost values during one or more time periods indicate the investment required to develop a minimum marketable feature. The return values indicate the money or other benefits, translated into financial terms, returned during one or more time periods to the stakeholders after implementing the developed minimum marketable feature. Next, in operation 1430, the stakeholders identify and evaluate architectural elements of the software product. Similar to minimum marketable features, architectural elements have cost values, indicating an investment during one or more time periods. However, the architectural elements do not have return values. Thus, the architectural elements can be any system or process, as long as the architectural elements have cost values and no return values.

Operation 1440 determines dependencies between minimum marketable features and architectural elements to identify strands. For example, minimum marketable features can be identified as A and B. An architectural element can be identified as 1. Further, if B is dependent on A and A is dependent on 1, then 1 is a precursor of A and A is a precursor of B. Thus, the nomenclature “1AB”, illustrates the dependencies and reveals the need for the development of 1 before A and A before B. Substrands of the strand 1AB are AB, 1A, 1, A, and B.

Each strand is composed of minimum marketable features and architectural elements. Thus, each cost and return value of a minimum marketable feature over multiple time periods and each cost value of an architectural element over multiple time periods determines a cash flow that describes a discounted cash flow (DCF) over multiple time periods. The DCF values are adjusted to present value (PV) at a particular interest rate to determine a net present value (NPV) of the strand. Although each strand is evaluated using NPV, other economic values are possible, as long as the economic values can be adjusted to identify strands. Thus, operation 1450 determines sequence adjusted net present values (SANPV) for each minimum marketable feature and architectural element of each strand. Specifically, the NPV of each strand is calculated for multiple time periods. Of course, each strand includes sequenced minimum marketable features and architectural elements.

Then, operation 1460 determines weighted sequence adjusted net present values (WSANPV) for each minimum marketable feature and architectural element of each strand. A weighting factor according to how long it takes to develop a strand is applied to each SANPV to adjust the economic values. Further, by determining the WSANPVs, quantitative metrics are derived that permit the selection of minimum marketable features and architectural elements to develop a software product.

Consequently, operation 1470 applies the incremental funding method heuristic to identify optimal delivery sequences. Specifically, by ranking the strands having WSANPVs for each time period, minimum marketable features and architectural elements can be scheduled for development for each time period. The scheduling continues until either all the minimum marketable features and architectural elements are scheduled or some other constraint, such as limited time periods for development are reached. Then, operation 1480 permits the examination of project metrics for possible application to fund the project

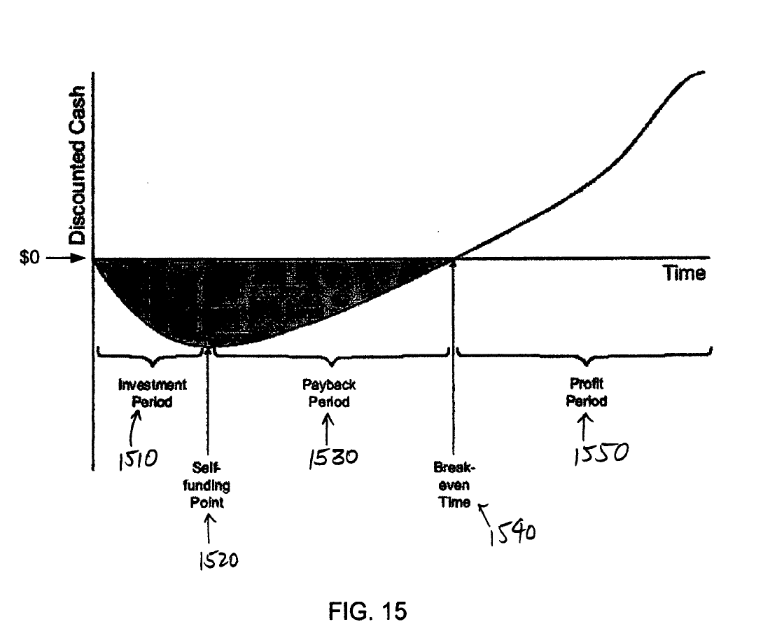

For example, FIG. 15 is a diagram illustrating project metrics of IFM, in accordance with an embodiment of the invention. A cash flow analysis requires the analysis of investment and revenue of a project over time. Specifically, after an investment period 1510, where the project only has investment costs, there is a self-funding point 1520. The self-funding point 1520 is the point at which no further investment is required to sustain the project. During the following payback period 1530, the investment cost is eventually returned to investors. A breakeven time 1540 is reached when the investment cost is paid. Subsequently, the cash flow enters a profit period 1550. The profit period 1550 indicates that all revenue during the remaining time of the project is profit.

These exemplary project metrics are used in the context of analyzing the effect of selection strands for development For example, if a first strand reaches the breakeven time 1540 faster than a second strand, and breakeven time is the overriding factor rather than NPV, it make sense to select the first strand for development. Thus, using the project metrics help stakeholders make financially informed decisions regarding the development of a software product

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

In the preceding description, numerous specific details are set forth in order to provide a thorough understanding of the present invention. It will be understood, however, by one of ordinary skill in the art, that the present invention may be practiced without some or all of these specific details. In other instances, well known process operations have not been described in detail in order not to unnecessarily obscure the present invention.

What is claimed is:

1. A method for developing a software product, comprising:
identifying a plurality of elements of the software product, each element being defined as a minimum marketable feature or an architectural element of the software product;
identifying dependencies of each of the plurality of elements, the dependencies between the plurality of elements and each element defining strands, wherein each strand has an economic value; and
adjusting the economic value of each strand for a plurality of time periods to produce a plurality of adjusted economic values that are referenced to identify a particular adjusted economic value for a time period of the plurality of time periods, the particular adjusted economic value being used to identify which of the plurality of elements are to be included in the software product.

2. The method of claim 1, further including: reviewing the plurality of adjusted economic values for strands in order to derive manually or by means of a heuristic or algorithm, the optimal, or near optimal sequence of development for the software product.

3. The method of claim 1, wherein the software product is developed by a service.

4. The method of claim 3, wherein the software product developed by the service includes a product that functions to provide services to develop the software product.

5. The method of claim 1, wherein identifying dependencies of each of the plurality of elements further includes defining precedence data for each strand.

6. The method of claim 5, wherein the precedence data identifies precursors of an element.

7. The method of claim 1, wherein defining the minimum marketable feature further includes identifying a unit of marketable value of the software product.

8. The method of claim 7, wherein identifying the unit of marketable value further includes,
creating marketable value by competitive differentiation;
creating marketable value by revenue generation;
creating marketable value by cost saving;
creating marketable value by brand projection; and
creating marketable value by enhanced loyalty.

9. The method of claim 1, wherein defining the minimum marketable feature further includes identifying a cost and return value.

10. The method of claim 1, wherein defining the architectural element further includes identifying a cost value.

11. The method of claim 1, wherein adjusting the economic value of each strand for the plurality of time periods further includes determining a sequence adjusted economic value.

12. The method of claim 11, wherein determining the sequence adjusted economic value further includes determining a weighted sequence adjusted economic value.

13. The method of claim 1, wherein referencing the time period further includes identifying the strand to develop the software product.

14. The method of claim 13, wherein identifying the strand further includes ranking the plurality of adjusted economic values.

15. The method of claim 1, wherein identification of the plurality of elements to be included in the software product further includes identifying a parallel delivery sequence of the plurality of elements.

16. The method of claim 1, wherein the identification of the plurality of elements to be included in the software product further includes determining a return on investment value.

17. A computer program embodied on a computer readable medium for developing a software product, comprising:
instructions for identifying a plurality of elements of the software product, each element being defined as a minimum marketable feature or an architectural element of the software product;
instructions for identifying dependencies of each of the plurality of elements, the dependencies between the plurality of elements and each element defining strands, wherein each strand has an economic value; and
instructions for adjusting the economic value of each strand for a plurality of time periods to produce a plurality of adjusted economic values that are referenced to identify a particular adjusted economic value for a time period of the plurality of time periods, the particular adjusted economic value being used to identify which of the plurality of elements are to be included in the software product.

18. The computer program of claim 17, wherein identifying dependencies of each of the plurality of elements further includes instructions for defining precedence data for each strand, the precedence data identifying precursors of an element.

19. The computer program of claim 17, wherein identifying the plurality of elements of the software product further includes instructions for identifying a unit of marketable value of the software product, the unit of marketable value, creating marketable value by competitive differentiation;
creating marketable value by revenue generation;
creating marketable value by cost saving;
creating marketable value by brand projection; and
creating marketable value by enhanced loyalty.

20. The computer program of claim 17, wherein adjusting the economic value of each strand for the plurality of time periods further includes instructions for determining a sequence adjusted economic value.

21. The computer program of claim 20, wherein determining the sequence adjusted economic value further includes instructions for determining a weighted sequence adjusted economic value.

22. The computer program of claim 17, wherein referencing the time period further includes instructions for identifying the strand to develop the software product.

23. The computer program of claim 22, wherein identifying the strand further includes instructions for ranking the plurality of adjusted economic values.

24. The computer program of claim 16, wherein identification of the plurality of elements to be included in the software product further includes instructions for identifying a parallel delivery sequence of the plurality of elements.

25. The computer program of claim 16, wherein the identification of the plurality of elements to be included in the software product further includes instructions for determining a return on investment value.

26. A method of developing a software product using a project management service, comprising:
identifying a minimum marketable feature or an architectural element of the software product;
identifying dependencies of the minimum marketable feature and the architectural element, the dependencies defining strands, wherein each strand has an economic value; and
adjusting the economic value of each strand for a plurality of time periods to produce a plurality of adjusted economic values that are referenced to identify a particular adjusted economic value for a time period of the plurality of time periods, the particular adjusted economic value being used to identify which of the plurality of elements are to be included in the software product.

27. The method of claim 26, wherein the strands define precedence data.

28. The method of claim 26, wherein adjusting the economic value of each strand further includes determining a sequence adjusted net present value for each strand

29. The method of claim 28, wherein determining the sequence adjusted net present value further includes determining a weighted sequence adjusted net present value for each strand.

30. The method of claim 26, wherein referencing the time period further includes identifying the strand to develop the software product.

31. The method of claim 30, wherein identifying the strand further includes ranking the plurality of adjusted economic values.

32. An apparatus for developing a software product, comprising:
means for identifying a plurality of elements of the software product, each element being defined as a minimum marketable feature or an architectural element of the software product;
means for identifying dependencies of each of the plurality of elements, the dependencies between the plurality of elements and each element defining strands, wherein each strand has an economic value; and
means for adjusting the economic value of each strand for a plurality of time periods to produce a plurality of adjusted economic values that are referenced to identify a particular adjusted economic value for a time period of the plurality of time periods, the particular adjusted economic value being used to identify which of the plurality of elements are to be included in the software product.
